(19) United States
(12) Patent Application Publication
(10) Pub. No.: US 2007/0043460 A1
(43) Pub. Date: Feb. 22, 2007

(54) Apparatus for audiocasting and method thereof

(75) Inventors: Eun-hee Rhim, Suwon-si (KR); Kwang-yun Na, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/500,394

(22) Filed: Aug. 8, 2006

(30) Foreign Application Priority Data
Aug. 17, 2005 (KR) 10-2005-0075253

(51) Int. Cl. G06F 17/00

(52) U.S. Cl. 700/94; 348/738

(57) ABSTRACT

An audiocasting apparatus and method reproducing a variety of audio broadcasting with an analog TV are provided. The apparatus includes a reception unit which selectively receives at least one audio broadcasting signal; an audio connection control unit which senses the reception unit, generates an audio broadcasting list of receivable audio broadcasting services, and controls the apparatus such that at least one broadcasting signal is received; a user interface unit which generates an audio broadcasting menu using the audio broadcasting list, receives an input of a selection signal relating to the audio broadcasting menu, and transfers the selection signal to the audio connection control unit; a signal conversion unit connected to the reception unit, which converts the selected audio broadcasting signal, so that the converted signal is reproduced by the analog TV; and an output unit which outputs the converted audio broadcasting signal to the analog TV.

### CROSS-REFERENCE TO RELATED PATENT APPLICATIONS

This application claims priority from Korean Patent Application No. 10-2005-0075253, filed on Aug. 17, 2005, in the Korean Intellectual Property Office, the disclosure of which is incorporated herein in its entirety by reference.

### BACKGROUND OF THE INVENTION

1. Field of the Invention

Apparatuses and methods consistent with the present invention relate to an audiocasting, and more particularly, to an audiocasting apparatus and method capable of reproducing a variety of audio broadcasting services with an analog television (TV).

2. Description of the Related Art

Although digital TVs capable of receiving digital broadcasting have been commercially produced, the digital TVs cannot replace analog TVs because the price of the digital TVs is expensive. The analog TV can receive only ground wave broadcasting broadcast in limited time bands, and the utilization degree of the analog TV is not high.

Meanwhile, audio broadcasting that is an important information transmission medium is generally broadcast in AM and FM bands. However, recently, Internet audio broadcasting through the Internet or digital multimedia broadcasting (DMB) through a ground network or a satellite network has been serviced.

Accordingly, an audiocasting apparatus capable of reproducing a variety of audio broadcasting services with the analog TV to enhance the utilization of the analog TV and allowing users to easily listen to a variety of audio broadcasting services is needed.

### SUMMARY OF THE INVENTION

The present invention provides an audiocasting apparatus and method capable of receiving and reproducing a variety of audiocasting signals with an analog TV.

According to an aspect of the present invention, there is provided an audiocasting apparatus for reproducing audio broadcasting on an analog TV, the apparatus including a reception unit selectively which receives at least one audio broadcasting signal; an audio connection control unit which senses the reception unit, generates an audio broadcasting list of audio broadcasting services receivable by the reception unit, and controls the apparatus such that at least one broadcasting signal among the broadcasting signals is received; a user interface unit which generates an audio broadcasting menu using the audio broadcasting list, receives an input of a selection signal in relation to the audio broadcasting menu, and transfers the selection signal to the audio connection control unit; a signal conversion unit connected to the reception unit, and which converts the audio broadcasting signal selected by the selection signal, so that the converted signal is reproduced by the analog TV; and an output unit which outputs the audio broadcasting signal converted in the signal conversion unit, to the analog TV.

The reception unit may include at least one of a radio reception apparatus which receives a radio broadcasting signal transmitted through a radio frequency (RF) signal; an Internet access apparatus which receives Internet broadcasting transmitted through the Internet; and a digital multimedia broadcasting DMB reception apparatus which receives digital multimedia broadcasting transmitted through a ground wave or a satellite.

If the audio broadcasting selected by the user has at least one audio channel, the audio connection control unit generates an audio broadcasting channel list, provides the audio broadcasting channel list to the user interface unit, and controls the apparatus such that the user interface unit generates an audio broadcasting channel menu.

If the reception unit is connected to the Internet access apparatus to be connected to the Internet and accesses an audio broadcasting site, if the audio broadcasting site requests authentication, the audio connection control unit may perform an authentication operation.

If the audio broadcasting content provider connected to the reception unit performs audio broadcasting with a protocol, the audio connection control unit may control so that the reception unit receives the broadcasting using the protocol.

According to another aspect of the present invention, there is provided an audiocasting apparatus to reproduce audio broadcasting of an analog TV, the apparatus including an audio connection control unit connected to an external reception terminal, which is capable of receiving and reproducing an audio broadcasting signal, and sensing the external reception terminal, generating an audio broadcasting list of audio broadcasting services received by the external reception terminal, and controlling so that at least one of the broadcasting signals is received; a user interface unit generating an audio broadcasting menu using the audio broadcasting list, receiving an input of a selection signal in relation to the audio broadcasting menu, and transferring the selection signal to the audio connection control unit; and an output unit outputting the audio broadcasting signal selected by the selection signal to the analog TV.

According to still another aspect of the present invention, there is provided an audiocasting method to reproduce audio broadcasting of an analog TV, the method including sensing an audio broadcasting reception apparatus capable of receiving an audio broadcasting signal; generating an audio broadcasting menu of audio broadcasting services received by the sensed audio broadcasting reception apparatus; receiving an audio broadcasting signal selected by receiving a selection signal in relation to the generated audio broadcasting menu; and converting the audio broadcasting signal in order for the analog TV to reproduce the converted signal, and outputting the converted signal to the analog TV.

According to yet still another aspect of the present invention, there is provided an audiocasting method to reproduce audio broadcasting of an analog TV, the method including being connected to an external reception terminal, which is capable of receiving and reproducing an audio broadcasting signal, and sensing the external reception terminal; generating an audio broadcasting menu of audio broadcasting services received by the sensed external reception terminal; receiving an audio broadcasting signal received by the external reception terminal selected by receiving a selection signal in relation to the generated audio broadcasting menu; and converting the audio broadcasting signal received by the external reception terminal in order for the analog TV to reproduce the converted signal, and outputting the converted signal to the analog TV.

### BRIEF DESCRIPTION OF THE DRAWINGS

The above and other aspects of the present invention will become more apparent by describing in detail exemplary embodiments thereof with reference to the attached drawings in which:

FIG. 1 illustrates an audiocasting system according to a exemplary embodiment of the present invention;

FIG. 2 is a block diagram showing the internal structure of an audiocasting TV including an audiocasting apparatus according to a exemplary embodiment of the present invention;

FIG. 3 is a block diagram showing the internal structure of an audiocasting TV including an audiocasting apparatus according to another exemplary embodiment of the present invention;

FIG. 4 is a flowchart of an audiocasting method according to a exemplary embodiment of the present invention; and

FIG. 5 is a flowchart of an audiocasting method according to another exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

In the present specification, audiocasting means receiving audio broadcasting through a variety of routes, or receiving audio broadcasting through an external reception terminal capable of receiving audio broadcasting and reproducing the audio broadcasting.

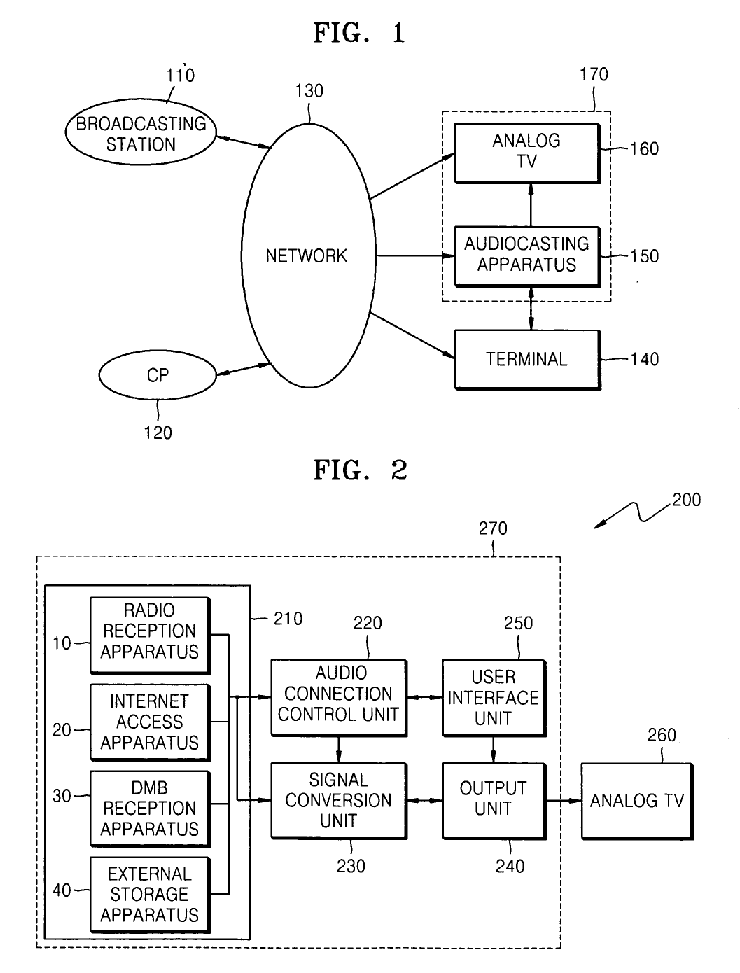

FIG. 1 illustrates an audiocasting system according to a exemplary embodiment of the present invention.

Referring to FIG. 1, an audio broadcasting system according to a exemplary embodiment of the present invention includes a broadcasting station 110, a content provider 120, a network 130, a terminal 140, an audiocasting apparatus 150, and an analog TV 160.

The broadcasting station 110 includes a radio broadcasting station mainly transmitting audio data and a TV broadcasting station transmitting video and audio data. Also, the broadcasting station 110 includes a broadcasting station servicing digital multimedia broadcasting. Also, the broadcasting station 110 can provide audio broadcasting through the Internet.

The content provider 120 provides webcasting through the network 130. Also, the content provider 120 may be a satellite DMB broadcasting service provider. The network 130 includes wired and wireless networks of the Internet, a local network, a cable network and a satellite network, and also includes communication routes through sky waves and ground waves.

The terminal 140 can be a radio receiver, a mobile phone, a DMB reception apparatus, an MP3 player with a networking function, for example, and can receive a variety of content and webcasting through the network 130.

Also, the terminal 140 can be connected to a terminal, such as a personal computer (PC), capable of being connected to a wired network and receiving audio broadcasting, in order to receive Internet broadcasting.

The audiocasting apparatus 150 according to a exemplary embodiment of the present invention receives audio broadcasting transmitted through a network. Also, the audiocasting apparatus 150 receives Internet audio broadcasting provided by a broadcasting station 110 or the content provider 120 that can be accessed through the terminal 140.

The audiocasting apparatus 150 receives audio broadcasting selected by a user between audio broadcasting directly transmitted through a network or audio broadcasting that can be received after the terminal 140 is connected, inputs the received audio broadcasting to the analog TV 160, and controls so that the analog TV 160 can reproduce the audio broadcasting.

Like the conventional TV, the analog TV 160 receives and reproduces a TV broadcasting program transmitted by the broadcasting station 110. Also, the analog TV 160 can reproduce audio broadcasting transmitted through a variety of routes using the audiocasting apparatus 150.

Referring to FIG. 1, the audiocasting apparatus 150 can be separated from and installed external to the TV 160. Also, the audiocasting apparatus 150 and the analog TV 160 can be integrated into an audiocasting TV 170 that is an improved analog TV. Meanwhile, though a broadcasting station 110 and a content provider 120 are shown in FIG. 1, there can be a plurality of broadcasting stations 110 and a plurality of content providers 120.

FIG. 2 is a block diagram showing the internal structure of an audiocasting TV including an audiocasting apparatus according to a exemplary embodiment of the present invention.

The audiocasting TV 200 according to the exemplary embodiment of the present invention includes an audiocasting apparatus 270, including a reception unit 210, an audio connection control unit 220, a signal conversion unit 230, an output unit 240, and a user interface unit 250, and the elements of a conventional analog TV 260.

The reception unit 210 includes a radio reception apparatus 10, an Internet access apparatus 20, and a DMB reception apparatus 30, and an external storage apparatus 40. Each of the reception apparatuses 10, 20, and 30 and the external storage apparatus 40 can be selectively included as required.

The radio reception apparatus 10 includes an RF tuner, and is tunes to one of a plurality of channels to receive a radio signal among a plurality of radio signals.

The Internet access apparatus 20 includes a network interface and receives webcasting transmitted through the Internet. The Internet access apparatus 20 has a local area network (LAN) card to be connected to an asymmetric digital subscriber line (ADSL) modem or a cable modem and can be implemented by hardware and software performing data communication through the Internet.

The DMB reception apparatus 30 is tuned to one of a plurality of channels to receive a digital broadcasting signal among a plurality of digital broadcasting signals. The external storage apparatus 40 is a detachable memory, such as a memory card or a universal serial bus (USB) memory stick. The external storage apparatus 40 allows the audiocasting apparatus 200 to output data stored in the memory, in addition to real-time broadcasting, to the analog TV 260.

The audio connection control unit 220 controls the entire audiocasting apparatus 270 and stores a control program to set an audiocasting mode in which audio broadcasting is received. Also, in order for the user interface unit 250 to generate a receivable audio broadcasting menu, the audio connection control unit 220 senses audio reception apparatuses that are included in the reception unit 210 and currently available, manages the list of the audio reception apparatuses, and transfers the list information to the user interface unit 250.

If the audio broadcasting selected by the user has at least one audio channel, the audio connection control unit (200) generates an audio broadcasting channel list, provides the audio broadcasting channel list to the user interface unit (250), and controls the apparatus 270 such that the user interface unit (250) generates an audio broadcasting channel menu.

Also, the audio connection control unit 220 performs site access authentication if a web site providing Internet broadcasting requires authentication. If an Internet site providing Internet broadcasting broadcasts using a protocol, the audio connection control unit 220 controls the apparatus 270 such that the protocol can be installed, or the Internet broadcasting can be received using the installed protocol. The network protocol used here can be a real-time transport protocol and a user datagram protocol (UDP), for example.

In relation to advertisement during audio broadcasting, the audio connection control unit 220 can output a mute signal if advertisement is performed according to user's setting through the user interface unit 250, or can control the apparatus 270 such that advertisement broadcasting, including program data which controls an advertisement signal to be copied and stored separately, can be selectively reproduced.

The signal conversion unit 230 converts a received audio broadcasting signal so that the analog TV 260 can receive and reproduce the signal. The signal conversion unit 230 may include a decoder (or decoding software) to decode a variety of forms of audio broadcasting signals, for example, a broadcasting signal in the form of packets, transferred through the reception unit 210, and a converter to convert a decoded digital audio signal into an analog audio signal. The decoded audio broadcasting signal is transferred to the output unit 240.

The output unit 240 synthesizes the audio data and video data converted in the signal conversion unit 220 and outputs the synthesized signal to the signal input unit of the analog TV 260. Additionally, graphic or text data input through the user interface unit 240 can be synthesized with the signal from the signal conversion unit 230 and output. Also, the output unit 240 may output the audio signal as an audio output of the analog TV 260 through bypass and control the volume.

The user interface unit 250 generates an audio broadcasting menu on the on screen display (OSD) of the analog TV 260 and receives a user input through a remote controller and the like. The user interface unit 250 provides a program for the audiocasting mode of the audio connection control unit 230 as a user interface, so that a button input function with which the user can select the audiocasting mode and receives audio broadcasting can be provided. Also, data input by the user (for example, text characters, ASCII characters, special characters, emoticons, etc.) in data transferred from the signal conversion unit 230 can be received and transferred to the output unit 240.

Additionally, in relation to advertisement broadcasting among audio broadcasting signals received, the user interface unit 250 provides a menu with which the user can set refusal of reception or permission of reception, so that the user can selectively receive advertisement broadcasting. The user interface unit 250 includes a wireless reception unit (not shown) receiving a control signal transmitted by a wireless transmitter, such as a remote controller of the analog TV 260, to receive a user input. The wireless reception unit can be constructed to receive IR, microwave, VHF, UHF, or other electromagnetic signals.

The analog TV 260 can receive the converted audio broadcasting signal from the output unit 240 and reproduce the audio broadcasting signal received through the audiocasting apparatus 270. The audiocasting apparatus 270 can be coupled with the analog TV 260 to be included in the integrated audiocasting TV 200 as shown in FIG. 2, or can be installed detachably external to the analog TV 260.

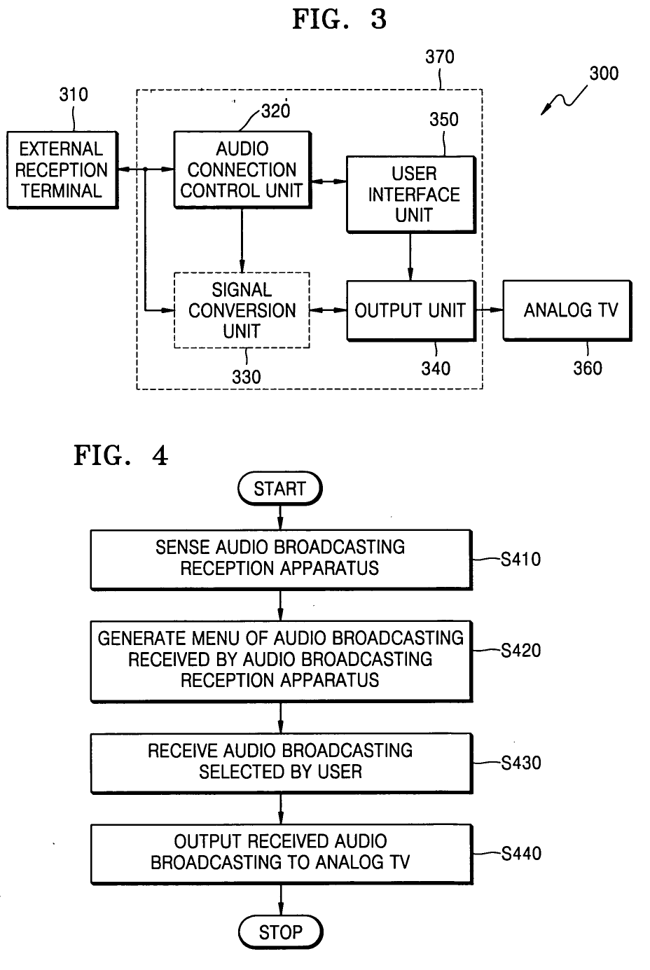

FIG. 3 is a block diagram showing the internal structure of an audiocasting TV including an audiocasting apparatus according to another exemplary embodiment of the present invention.

The audiocasting TV 300 according to the exemplary embodiment performs audiocasting after being connected to an external reception terminal 310 capable of receiving and reproducing audio broadcasting, instead of the reception unit 210 of FIG. 2. The audiocasting TV 300 may include a cradle (not shown) that can interact with the audiocasting TV 300 by attaching an external reception terminal.

Using a USB port and the like, the audiocasting TV 300 is connected to the external reception terminal 310 that can receive a variety of audio broadcasting services. The external reception terminal 310 includes a radio reception terminal, a mobile phone, a personal data assistant (PDA), an MP3 device capable of receiving web broadcasting, and a DMB terminal capable of receiving DMB broadcasting. The external reception terminal 310 can have a wireless network card to be connected directly to an audio content provider through a wireless connection to the Internet. Also, the external reception terminal 310 can be connected to an apparatus, such as a computer, in order to access an audio content providing site, and through a program for downloading music data, can receive audio broadcasting. Also, the external reception terminal 310 can be an apparatus capable of accessing an ordinary website providing audio Internet broadcasting through an Ethernet connection.

According to the selection of a channel by the user transferred through the user interface unit 350, the audio connection control unit 320 can drive the connection interface with the external reception terminal 310, establish a connection, and begin an audiocasting session.

The external reception terminal 310 may be configured to convert an audio broadcasting signal to a signal that can be reproduced by the analog TV 360, and the audio broadcasting received through the external reception terminal 310 is transferred to the output unit 340 without passing through the signal conversion unit as in the exemplary embodiment of FIG. 2. However, if the external reception terminal 310 is not configured to convert an audio broadcasting signal to a signal that can be reproduced by the analog TV 360, the audiocasting apparatus 270 includes the signal conversion unit 330 to convert the audio broadcasting signal.

The audio broadcasting transferred through the output unit 340 is reproduced in the analog TV 360. The remaining elements of FIG. 3 have similar features and structures as those of corresponding elements in FIG. 2. Accordingly, in the audiocasting TV 300, the audio broadcasting received by the external reception terminal 310 connected to the audio connection control unit 320 can be reproduced using the analog TV 360.

FIG. 4 is a flowchart of an audiocasting method according to a exemplary embodiment of the present invention.

If a user selects an audiocasting mode, an audiocasting TV, including an audiocasting apparatus or an audiocasting apparatus installed external to an analog TV, senses a audio broadcasting reception apparatus capable of receiving an audio broadcasting signal included in a reception unit in operation S410.

An audio broadcasting menu that can be received by the audio broadcasting reception apparatus is generated in order for the user to recognize the menu, and provided so that the user can select an audio broadcasting service by inputting a selection signal in operation S420.

Audio broadcasting is received using the audio broadcasting reception apparatus that can receive audio broadcasting selected by the user in operation S430. Meanwhile, if an Internet site providing Internet broadcasting requires user authentication, user authentication can be performed. Also, if an audio broadcasting content provider providing audio broadcasting content to the reception unit uses a protocol to provide the broadcasting, reception of the Internet broadcasting can be controlled using the protocol.

If the selected audio broadcasting reception apparatus provides audio broadcasting through one or more channels, a list in relation to the audio broadcasting channels is generated, and a menu that can be recognized by the user is generated from the list. An audio broadcasting channel selected by the user in the generated menu is received such that the audio broadcasting can be received. The audio broadcasting selected by the user and received is converted into a signal that can be reproduced by the analog TV and is output to the analog TV in operation S440. Additionally, if the user sets refusal of reception of advertisement broadcasting in advance, a mute signal can be made to be output during the reception of the advertisement broadcasting.

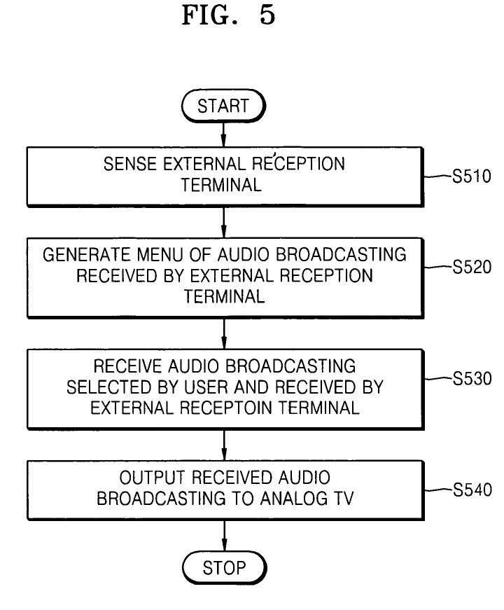

FIG. 5 is a flowchart of an audiocasting method according to another exemplary embodiment of the present invention.

If a user selects an audiocasting mode, an audiocasting TV having an audiocasting apparatus or an audiocasting apparatus connected to the external reception terminal installed external to an analog TV, senses an external reception terminal that can receive and reproduce audio broadcasting signal in operation S510. An audio broadcasting menu that is received by the external reception terminal is generated in order for the user to recognize the menu, and the menu is provided to the user so that the user can select an audio broadcasting service in the menu by inputting a selection signal in operation S520.

An, audio, broadcasting service selected by the user in the generated audio broadcasting menu is received using the external reception terminal capable of receiving audio broadcasting in operation S530.

If the selected external reception terminal provides audio broadcasting through one or more channels, a list in relation to the audio broadcasting channels is generated, and a menu that can be recognized by the user is generated from the list. Then, a audio broadcasting channel selected by the user in the generated menu is received.

The audio broadcasting received through the external reception terminal is converted into a signal that can be reproduced by the analog TV, in the external reception terminal and is output to the analog TV in operation S540.

According to the present invention, a function capable of accessing a variety of content networks, such as the Internet, is added to a TV so that an audiocasting signal transmitted through a variety of interfaces can be output in the TV.

By doing so, the utilization degree of an analog TV receiving only given broadcasting channels can be enhanced.

The audiocasting method of the present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments, it will be understood by those of ordinary skill in the art that various changes in form and details may be made therein without departing from the spirit and scope of the present invention as defined by the following claims. The exemplary embodiments described herein should be considered in descriptive sense only and not as limiting the scope of the invention.

What is claimed is:

1. An audiocasting apparatus comprising:
a reception unit which selectively receives at least one audio broadcasting signal;
an audio connection control unit which generates an audio broadcasting list of audio broadcasting services receivable by the reception unit;
a signal conversion unit which is connected to the reception unit, and converts the audio broadcasting signal, to a converted signal that is reproducible by an analog television.

2. The apparatus of claim 1, further comprising a user interface unit which generates an audio broadcasting menu using the audio broadcasting list, receives an input selection signal with regard to the audio broadcasting menu, and transfers the selection signal to the audio connection control unit,
wherein the audio control connection unit controls the reception unit to receive and output the audio broadcasting signal selected by the selection signal.

3. The apparatus of claim 1, wherein the reception unit comprises at least one of:
a radio reception apparatus which receives a radio broadcasting signal transmitted through a radio frequency (RF) signal;
an Internet access apparatus which receives Internet broadcasting transmitted through the Internet; and
a digital multimedia broadcasting (DMB) reception apparatus which receives digital multimedia broadcasting transmitted through a ground wave or a satellite; and
the audio connection unit senses the at least one of the radio reception apparatus, the Internet access apparatus and the DMB reception apparatus.

4. The apparatus of claim 1, further comprising an output unit which outputs the audio broadcasting signal converted in the signal conversion unit, to the analog television.

5. The apparatus of claim 2, wherein if the audio broadcasting signal selected by the user has at least one audio channel, the audio connection control unit generates an audio broadcasting channel list, provides the audio broadcasting channel list to the user interface unit, and controls the user interface unit to generate the audio broadcasting channel menu.

6. The apparatus of claim 3, wherein if the reception unit is connected to the Internet access apparatus to be connected to the Internet and accesses an audio broadcasting site, and if the audio broadcasting site requests authentication, the audio connection control unit performs an authentication operation.

7. The apparatus of claim 1, wherein if an audio broadcasting content provider connected to the reception unit performs audio broadcasting with a protocol, the audio connection control unit controls the reception unit to receive and output the audio broadcasting using the protocol.

8. An audiocasting apparatus comprising:
an audio connection control unit which is connected to an external reception terminal, capable of receiving and reproducing an audio broadcasting signal, senses the external reception terminal, generates an audio broadcasting list of audio broadcasting services received by the external reception terminal, and controls the external reception apparatus to receive and output at least one of the broadcasting signals; and
an output unit which outputs the audio broadcasting signal to an analog television.

9. The apparatus of claim 8, further comprising a user interface unit which generates an audio broadcasting menu using the audio broadcasting list, receives an input selection signal with regard to the audio broadcasting menu, and transfers the selection signal to the audio connection control unit,
wherein the output unit outputs the audio broadcasting signal selected by the selection signal to the analog television.

10. The apparatus of claim 8, further comprising:
a signal conversion unit which converts the audio broadcasting signal so that the converted signal is reproducible by the analog television.

11. The apparatus of claim 8, wherein the external reception terminal comprises at least one of:
a radio reception terminal which receives a radio broadcasting signal transmitted through a radio frequency (RF) signal;
an Internet access terminal which receives Internet broadcasting transmitted through the Internet; and
a digital multimedia broadcasting (DMB) reception terminal which receives DMB transmitted through a ground wave or a satellite wave.

12. The apparatus of claim 9, wherein if an audio broadcasting selected by the user has at least one audio channel, the audio connection control unit generates an audio broadcasting channel list, provides the audio broadcasting channel list to the user interface unit, and controls the apparatus such that the user interface unit generates the audio broadcasting channel menu.

13. The apparatus of claim 8, wherein if the external reception terminal is connected to the Internet access terminal to be connected to the Internet and accesses an audio broadcasting site, and if the audio broadcasting site requests authentication, the audio connection control unit performs an authentication operation.

14. The apparatus of claim 8, wherein if an audio broadcasting content provider connected to the external reception terminal performs audio broadcasting with a protocol, the audio connection control unit controls the reception unit to receive and output the audio broadcasting using the protocol.

15. An audiocasting method comprising:
sensing an audio broadcasting reception apparatus capable of receiving at least one audio broadcasting signal;
generating an audio broadcasting menu of audio broadcasting services received by the sensed audio broadcasting reception apparatus;
receiving an audio broadcasting signal selected by a selection signal with regard to the generated audio broadcasting menu; and
converting the audio broadcasting signal to a converted signal that is reproducible by an analog television.

16. The method of claim 15, wherein in the receiving of the audio broadcasting signal comprises receiving at least one of a radio broadcasting signal transmitted through a radio frequency (RF) signal, Internet broadcasting transmitted through the Internet, and digital multimedia broadcasting transmitted through a ground wave or a satellite wave.

17. The method of claim 16, further comprising outputting the converted signal to the analog TV

18. The method of claim 16, wherein if the audio broadcasting signal received by the audio broadcasting reception apparatus has at least one channel, the receiving of the audio broadcasting signal further comprises:
generating a list of the audio broadcasting channels, and generating the audio broadcasting channel menu from the generated list; and
receiving an audio broadcasting signal transmitted through an audio broadcasting channel selected by a selection signal with regard to the generated menu.

19. The method of claim 16, further comprising performing user authentication if the Internet site providing the Internet broadcasting requires user authentication.

20. The method of claim 16, further comprising if an audio broadcasting content provider providing audio broadcasting contents to the reception unit performs broadcasting using a protocol, controlling the audio broadcasting apparatus to receive the audio broadcasting contents using the protocol.

21. An audiocasting method comprising:
sensing the external reception terminal which is capable of receiving and reproducing an audio broadcasting signal;
generating an audio broadcasting menu of audio broadcasting services received by the sensed external reception terminal;
receiving an audio broadcasting signal received by the external reception terminal selected by a selection signal with regard to the generated audio broadcasting menu; and
converting the audio broadcasting signal received by the external reception terminal to a converted signal that is reproducible by an analog television, and outputting the converted signal to the analog TV.

22. The method of claim 21, wherein in the receiving of the audio broadcasting signal comprise receiving at least one of a radio broadcasting signal received by a radio reception terminal transmitted through a radio frequency (RF) signal, Internet broadcasting received by an Internet access terminal transmitted through the Internet, and digital multimedia broadcasting (DMB) broadcasting received by a DMB reception terminal transmitted through a ground wave or a satellite wave.

23. The method of claim 21, wherein if the selected external reception terminal receives audio broadcasting through at least one channel, the receiving of the audio broadcasting signal further comprises:
generating a list of the audio broadcasting channels, and generating an audio broadcasting channel menu from the generated list; and
receiving the audio broadcasting signal transmitted through an audio broadcasting channel selected by receiving the selection signal with regard to the generated menu.

24. The method of claim 22, further comprising performing user authentication if the Internet site providing the Internet broadcasting requires user authentication.

25. The method of claim 21, further comprising if an audio broadcasting content provider providing audio broadcasting contents to the external reception terminal performs broadcasting using a protocol, controlling the audio broadcasting apparatus to receive the audio broadcasting contents using the protocol.

26. A computer readable recording medium having embodied thereon a computer program executing a method comprising:
sensing an audio broadcasting reception apparatus capable of receiving at least one audio broadcasting signal;
generating an audio broadcasting menu of audio broadcasting services received by the sensed audio broadcasting reception apparatus;
receiving an audio broadcasting signal selected by a selection signal with regard to the generated audio broadcasting menu; and
converting the audio broadcasting signal to a converted signal that is reproducible by an analog television.

27. A computer readable recording medium having embodied thereon a computer program executing a method comprising:
sensing the external reception terminal which is capable of receiving and reproducing an audio broadcasting signal;
generating an audio broadcasting menu of audio broadcasting services received by the sensed external reception terminal;
receiving an audio broadcasting signal received by the external reception terminal selected by a selection signal with regard to the generated audio broadcasting menu; and
converting the audio broadcasting signal received by the external reception terminal to a converted signal that is reproducible by an analog television, and outputting the converted signal to the analog television.
